(19) United States
(12) Patent Application Publication
(10) Pub. No.: US 2025/0315718 A1
(43) Pub. Date: Oct. 9, 2025

(54) MAPPING DISPARATE LANGUAGE-BASED DATASETS USING A LANGUAGE MODEL

(71) Applicant: INTUIT INC., Mountain View, CA (US)

(72) Inventors: Diane Zhang TAM, San Diego, CA (US); Xue HAN, Sunnyvale, CA (US)

(73) Assignee: INTUIT INC., Mountain View, CA (US)

(21) Appl. No.: 18/627,230

(22) Filed: Apr. 4, 2024

(51) Int. Cl. G06N 20/00

(52) U.S. Cl. CPC G06N 20/00

(57) ABSTRACT

A method including receiving a prompt for a language model trained to process natural language data. The prompt commands the language model. The method also includes generating an updated prompt by at least injecting a feature into the prompt. The method also includes applying a vector generation controller to the updated prompt to generate a set of prompt embedding vectors. The method also includes applying the vector generation controller to a language dataset to generate a set of term embedding vectors. The language dataset includes terms disparate from the feature. The method also includes combining the set of term embedding vectors with the set of prompt embedding vectors to generate a set of combined vectors. The method also includes applying the language model to the set of combined vectors to generate a mapping between the feature and a term in the terms. The method also includes presenting the mapping.

### BACKGROUND

In certain computer science applications, it may be useful to map one dataset to another. For example, it may be useful to map social security numbers (one dataset) to employee numbers (a second dataset) in order to automatically reference one dataset with the second dataset. However, certain data mapping tasks may be difficult or impractical for a computer to perform. For example, when two or more datasets are natural language strings, only have a weak logical connection, or evolve over time, mapping the first dataset to the second dataset may be difficult or impractical.

In a specific example, a set of features usable by a machine learning model may be expressed in natural language text. The set of features may include hundreds or thousands of features. The task in this specific example may be to map one or more of the set of features to a set of natural language codes. The set of natural language codes may include only tens or hundreds of natural language codes, meaning a one-to-one correspondence between features and codes does not exist. Furthermore, any given feature and any given code may be only weakly associated, or may have a non-obvious connection. Yet further, the natural language codes, the features, or both, evolve over time. Still further, the relationships between the features and the codes evolve over time, or may be dependent on varying factors (such as the identity of an entity to which the features or codes may apply). Because of the difficulties mentioned above, the features and the codes are considered disparate language-based datasets. It may not be possible or practicable to create a set of rules that automatically map the disparate language-based datasets.

### SUMMARY

One or more embodiments relate to a method. The method includes receiving a prompt for a language model trained to process natural language data. The prompt commands the language model. The method also includes generating an updated prompt by at least injecting a feature into the prompt. The method also includes applying a vector generation controller to the updated prompt to generate a set of prompt embedding vectors. The method also includes applying the vector generation controller to a language dataset to generate a set of term embedding vectors. The language dataset includes terms disparate from the feature. The method also includes combining the set of term embedding vectors with the set of prompt embedding vectors to generate a set of combined vectors. The method also includes applying the language model to the set of combined vectors to generate a mapping between the feature and a term in the terms. The method also includes presenting the mapping.

One or more embodiments also provide for a system. The system includes a processor and a data repository in communication with the processor. The data repository stores a prompt and an updated prompt. The data repository also stores a language dataset including terms, which includes a term. The data repository also stores a set of prompt embedding vectors, a set of term embedding vectors, and a set of combined vectors. The data repository also stores a feature and a mapping between the feature and the term. The feature is disparate from the terms. The system also includes a language model executable by the processor and trained to process natural language data. The prompt commands the language model. The system also includes a vector generation controller executable by the processor. The system also includes a mapping controller programmed, when executed by the processor, to perform a computer-implemented method. The computer-implemented method includes receiving the prompt. The computer-implemented method also includes generating the updated prompt by injecting the feature into the prompt. The computer-implemented method also includes applying the vector generation controller to the updated prompt to generate a set of prompt embedding vectors. The computer-implemented method also includes applying the vector generation controller to the language dataset to generate the set of term embedding vectors. The computer-implemented method also includes combining the set of term embedding vectors with the set of prompt embedding vectors to generate the set of combined vectors. The computer-implemented method also includes applying the language model to the set of combined vectors to generate the mapping. The computer-implemented method also includes returning the mapping.

One or more embodiments provide for another method. The method includes receiving a list of terms. The method also includes receiving verbiage corresponding to the list of terms. Each term in the list of terms corresponds to a set of verbiage in the verbiage. The method also includes receiving metadata. Each term in the list of terms corresponds to a set of metadata in the metadata. The method also includes transforming the list of terms, the verbiage, and the metadata into a language dataset including a set of data structure files. Each file in the set of data structure files includes a triplet of a term, the set of verbiage for the term, and the set of metadata for the term. The method also includes applying a vector generation controller to the language dataset to generate term embedding vectors. Each of the term embedding vectors includes one or more embedding vectors corresponding to a file in the set of data structure files. The method also includes storing the term embedding vectors in a non-transitory computer readable storage medium. The method also includes storing prompt templates in the non-transitory computer readable storage medium. Each of the prompt templates includes a command to map a feature to one or more terms in the list of terms. The method also includes storing variable prompts in the non-transitory computer readable storage medium, the variable prompts configured to modify the prompt templates.

### BRIEF DESCRIPTION OF DRAWINGS

FIG. 1A and FIG. 1B shows a computing system, in accordance with one or more embodiments.

FIG. 2 shows a flowchart of a method for mapping disparate language-based datasets using a language model, in accordance with one or more embodiments.

FIG. 3A and FIG. 3B show a dataflow for mapping disparate language-based datasets using a language model, in accordance with one or more embodiments.

FIG. 4A shows an example of using a mapping disparate language-based dataset using a language model in a particular application, in accordance with one or more embodiments.

FIG. 4B and FIG. 4C show examples of prompts and prompt variables, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to a method for mapping disparate language-based datasets using a language model. Briefly, one or more terms of a first dataset are combined into a prompt. The prompt is converted into a first set of vectors. Multiple terms of a second, disparate dataset, are converted into a second set of vectors. The two sets of vectors are combined and provided to a language model. The language model outputs a mapping between the one or more terms of the first dataset and the multiple terms of the second dataset.

In a brief example, assume a feature (expressible in natural language text) is determined to be one feature, selected from among many features used by a prediction model to generate a prediction, that most contributed to a prediction by a prediction machine learning model. It is desirable to map the feature to one or more text codes among multiple text codes. The text codes may be used to automatically generate natural language messages explaining the reason the machine learning model output the prediction. However, there is no obvious connection or no stable connection between the feature and any of the multiple text codes.

Thus, a mapping procedure of one or more embodiments may be used to map the feature to one or more of the text codes. A prompt is generated using the feature. The prompt is converted into prompt embedding vectors. The multiple text codes, previously converted into term embedding vectors, are stored in a database. The prompt embedding vectors are combined with the term embedding vectors to generate combined vectors. The combined vectors are provided as input to a language model, such as a large language model. The language model outputs a mapping between the feature and one or more of the text codes.

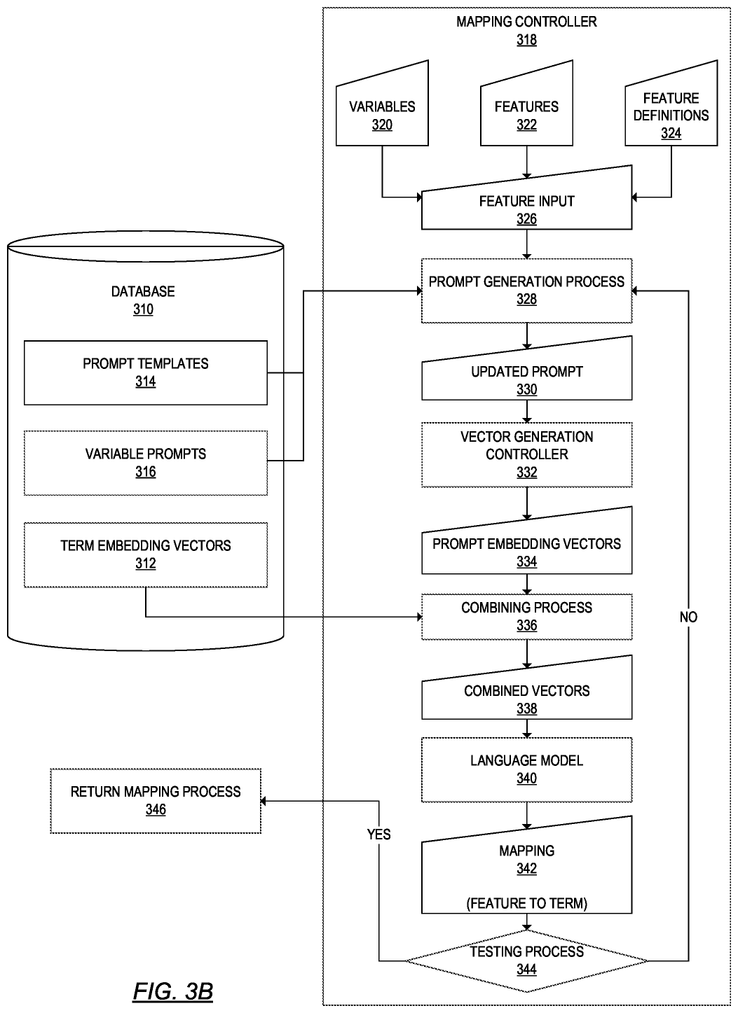

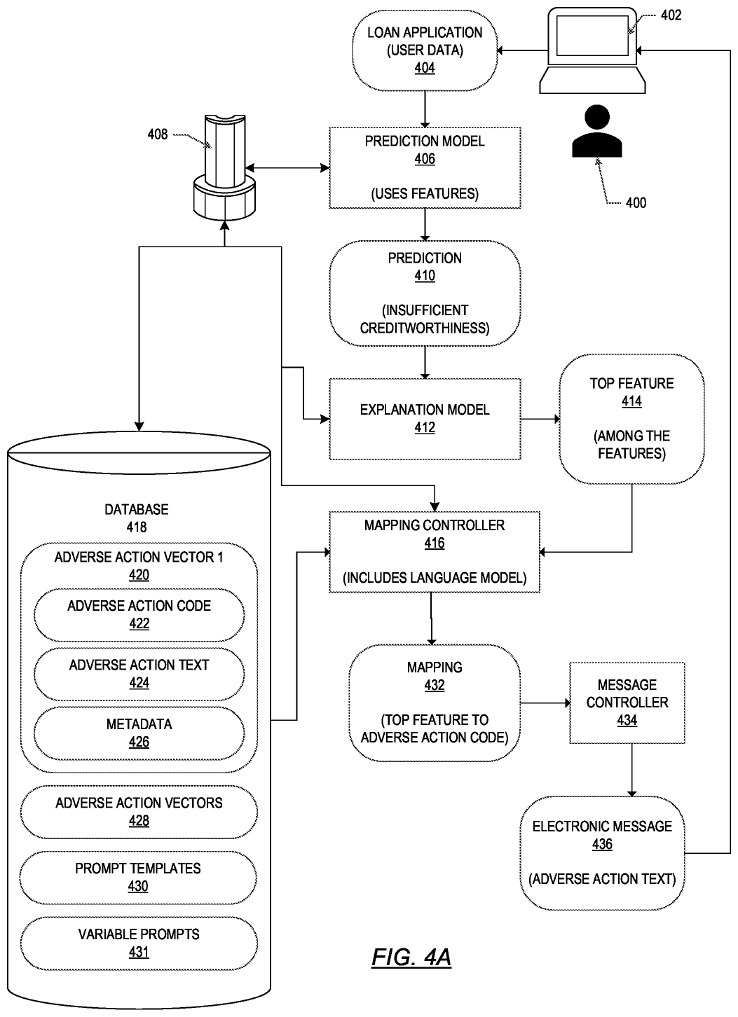

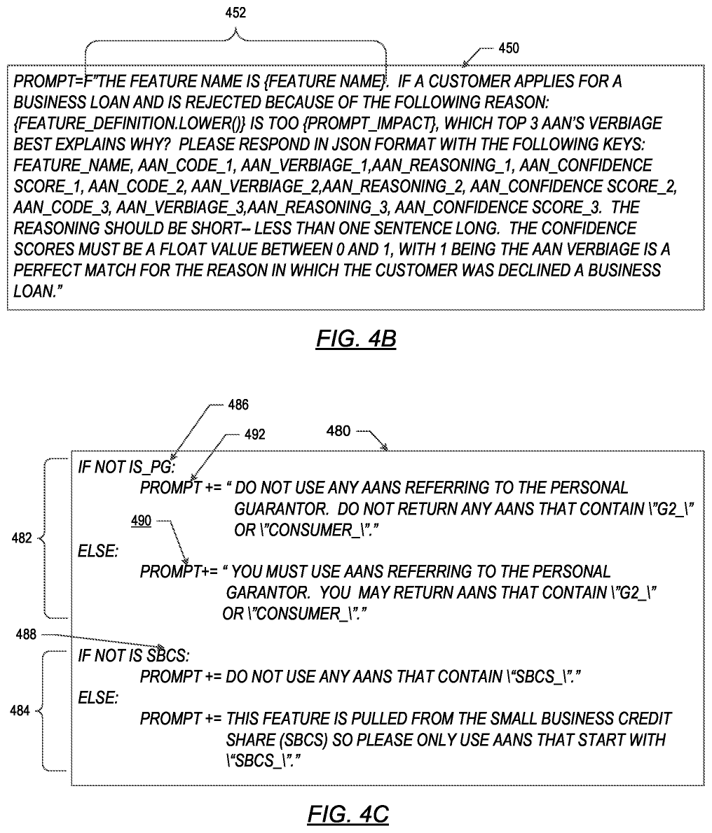

Once the mapping is available, the one or more text codes may be used to generate an electronic message. The electronic message may then be transmitted to a user for whom the prediction was generated. The electronic message explains to the user, in natural language text, why the prediction applied to the user. A more specific example of the above procedure is described in FIG. 4A.

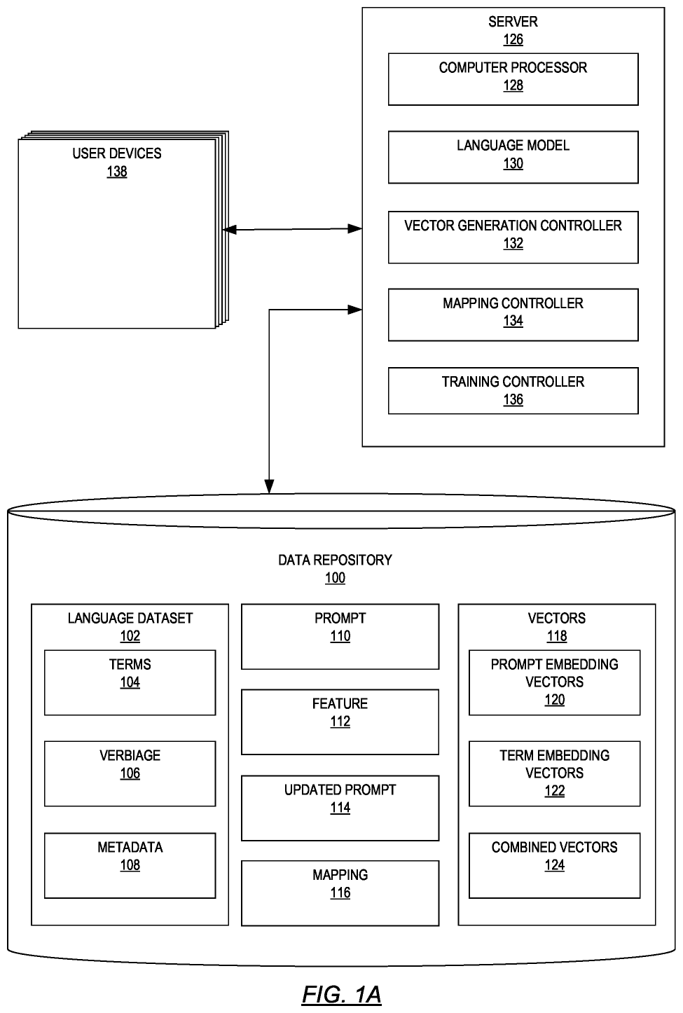

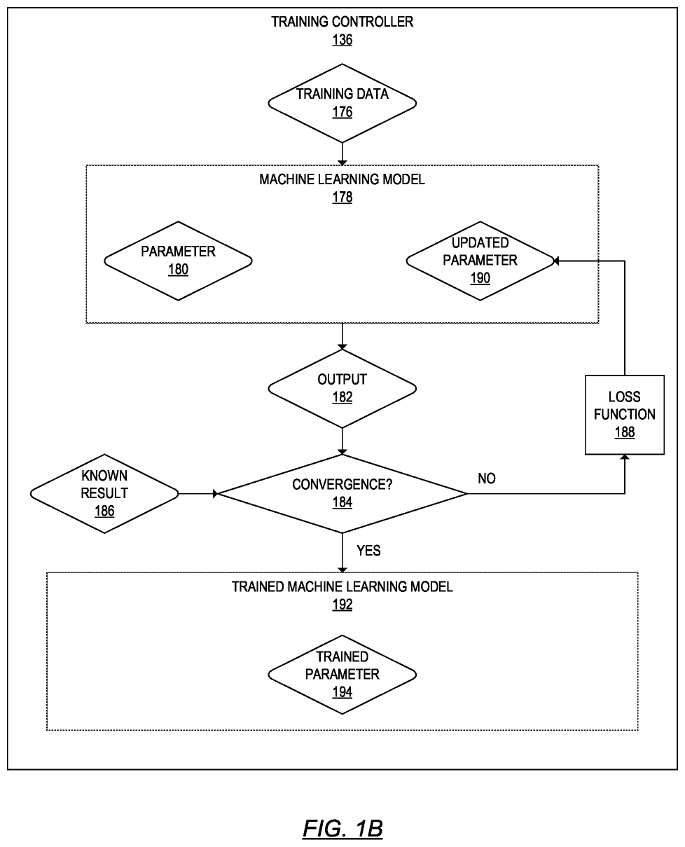

Attention is now turned to the figures. FIG. 1A and FIG. 1B shows a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a language dataset (102). The language dataset (102) is a computer-readable data structure that stores natural language text. The language dataset (102) at least includes one or more terms (104). The terms (104) are text strings, such as words. It may be desirable to map the terms (104) to one or more second, disparate language datasets. In the example of FIG. 1A, the feature (112), defined below, may be the second, disparate language dataset. As used herein, the term “disparate” means that two datasets have a measurable semantic distance (as measured by a semantic machine learning model) that is above a threshold value.

The language dataset (102) may include additional information. For example, the language dataset (102) may include verbiage (106) associated with the terms (104). In a specific example, one set of the verbiage (106) may be associated with a term in the terms (104). For example, if the term of the terms (104) is “insufficient data,” then the set of the verbiage (106) associated with the term may be “there was insufficient data to complete the data processing function.”

The language dataset (102) may include still further information. For example, the language dataset (102) may include metadata (108) associated with the terms (104). In a specific example, one set of the metadata (108) may be associated with a term in the terms (104). For example, if the term of the terms (104) is “insufficient data,” then the set of the metadata (108) may be “program name”, which represents the name of the data processing function mentioned with respect to the set of the verbiage (106), above.

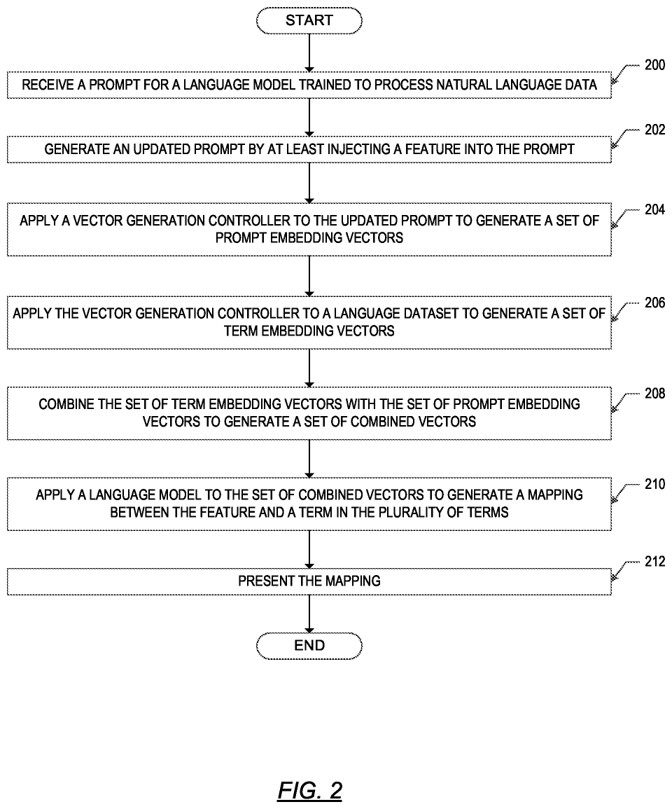

The verbiage (106) and the metadata (108) provide additional context which the language model (130) (described below) may process when performing a mapping operation, such as the mapping operation shown in FIG. 2. The verbiage (106) also may be used in later processing functions after the mapping process. For example, the set of verbiage (106) corresponding to a term of the terms (104) may form the basis of an electronic message to be sent to a user.

The language dataset (102) may be arranged into one or more individual files Each file includes a triplet of one term in the terms (104), one set of the verbiage (106) associated with the term, and one set of the metadata (108) associated with the term.

The files representing the language dataset (102) are data structures. The files may be, for example, tab separated value data structures. The files may be object notation data structures, such as JAVASCRIPT® object notation (JSON) files.

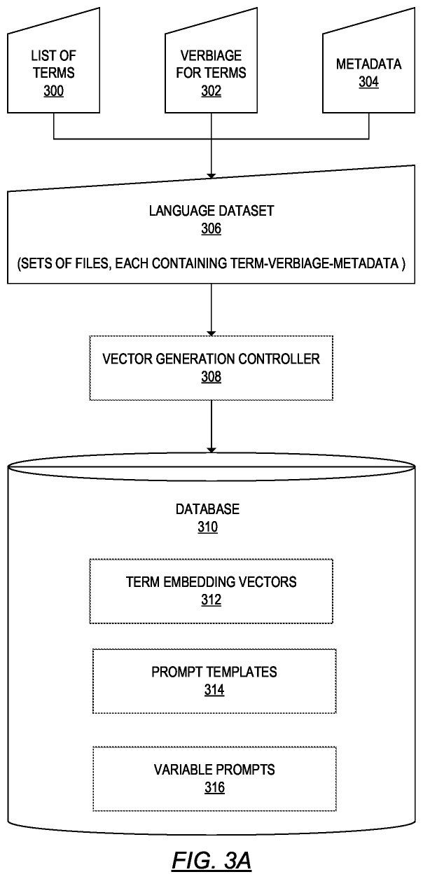

The data repository (100) also stores a prompt (110). The prompt (110) is a command, expressed in natural language text, to a language model (such as the language model (130) described below). The command may be to map a feature (112) (described below) to one or more of the terms (104) in the language dataset (102). The process of executing the prompt is described with respect to FIG. 2 and FIG. 3B. An example of the prompt (110) and use of the example of the prompt (110) is provided below with respect to FIG. 4B.

The prompt (110) may be a dynamically generated prompt. A dynamically generated prompt may be generated from a prompt template that includes the base commands for the prompt (110), together with commands to accept a variable prompt. The variable prompt is determined when the prompt (110) to be executed is generated. An example of the variable prompt is shown in FIG. 4C.

The data repository (100) may store a feature (112). While the term “a feature” is used, one or more embodiments contemplate that the feature (112) may be multiple features that are to be mapped to the language dataset (102).

In one example, the feature (112) may be selected from among many features that a prediction model used in the process of outputting a prediction. In this case, the feature (112) is the selected feature (e.g., a “first” feature) that was determined to have been the top feature that most contributed to the prediction that was output by the prediction model. However, the feature (112) may be read as being a set of multiple features that were determined to have most contributed to the prediction that was output by the prediction model. In this latter case, the subsequent mapping procedure described below may be performed for each of the features in the set of multiple features.

The feature (112) is a member of a second dataset that is disparate from the terms (104), and thus disparate from the language dataset (102). One or more embodiments contemplate utility in mapping a machine learning feature (which is used by a prediction model to generate a prediction (see FIG. 4A)) to a term in the terms (104). Thus, in the example of FIG. 1A the feature (112) may be a machine learning feature.

However, the feature (112) may be other types of natural language datasets, other than features used by prediction models. For example, the feature (112) may be replaced with a second term set that is disparate from the terms (104). The second term set are not machine learning features. Accordingly, use of the word “feature” in reference to the examples herein and in the claims includes the possibility that the feature (112) is one or more natural language terms that are not machine learning features.

The data repository (100) also stores an updated prompt (114). The updated prompt (114) is the prompt (110) after at least the feature (112) has been injected into the prompt (110). Thus, the updated prompt (114) includes both the prompt (110) and the feature (112). The updated prompt (114) also may include additional information from a variable prompt, such as shown in FIG. 4C.

The data repository (100) also stores a mapping (116). The mapping (116) is a data structure that specifies that a term in the terms (104) is associated with or maps to the feature (112) (or one of the second terms that form the feature (112)). For example, the mapping (116) may be an object notation language data structure (e.g., a JSON file) specifying the feature (112) and the term (from the terms (104)) that correspond to the feature (112). The mapping (116) is generated according to the method of FIG. 2, as further exemplified in the dataflow of FIG. 3B.

The data repository (100) also stores one or more vectors (118). A vector is a computer-readable data structure. A vector may take the form of a matrix, an array, a graph, or some other data structure. However, a frequently used form of vector is a one by N matrix, where each cell of the matrix represents the value for one feature.

A machine learning feature is a type of data (e.g., a color of an object, the presence of a word or alphanumeric text, a physical measurement type, etc.) A value is a numerical or other recorded specification of the feature. For example, if the machine learning feature is the word “cat,” and the word “cat” is present in a corpus of text, then the value of the machine learning feature may be “1” (to indicate a presence of the feature in the corpus of text). Again, the feature (112) may be a machine learning feature. However, the feature (112) is not necessarily limited to a machine learning feature, as described above.

The vectors (118) may include a number of prompt embedding vectors (120). The prompt embedding vectors (120) are one or more vectors (118) that represent the prompt (110) or the updated prompt (114) after the vector generation controller (132) has been applied to the prompt (110) or the updated prompt (114). Thus, the vector generation controller (132) transforms (i.e., vectorizes) the prompt (110) or the updated prompt (114) into the prompt embedding vectors (120).

The vectors (118) include a number of term embedding vectors (122). The term embedding vectors (122) are one or more vectors that represent the terms (104) or the language dataset (102) after the vector generation controller (132) has been applied to the terms (104) or the language dataset (102). Thus, the vector generation controller (132) transforms (i.e., vectorizes) the terms (104) or the language dataset (102) into the prompt embedding vectors (120).

The vectors (118) also include one or more combined vectors (124). The combined vectors (124) are a combination of the prompt embedding vectors (120) and the term embedding vectors (122). For example, the term embedding vectors (122) may be appended to, concatenated with, interspersed with, or otherwise combined with the prompt embedding vectors (120). The combined vectors (124) may form the input to the language model (130) during the method of FIG. 2.

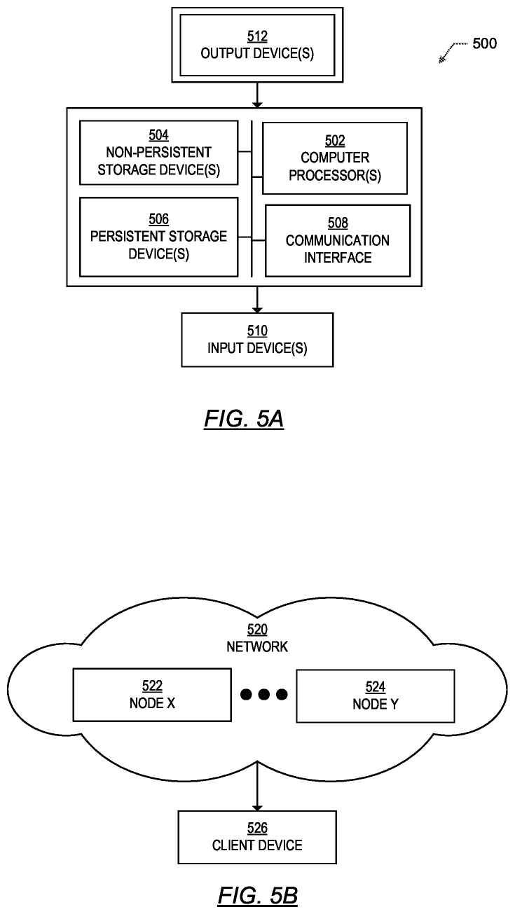

The system shown in FIG. 1A may include other components. For example, the system shown in FIG. 1A also may include a server (126). The server (126) is one or more computer processors, data repositories, communication devices, and supporting hardware and software. The server (126) may be in a distributed computing environment. The server (126) is configured to execute one or more applications, such as the language model (130), the vector generation controller (132), the mapping controller (134), or the training controller (136). An example of a computer system and network that may form the server (126) is described with respect to FIG. 5A and FIG. 5B.

The server (126) includes a computer processor (128). The computer processor (128) is one or more hardware or virtual processors which may execute computer readable program code that defines one or more applications, such as the language model (130), the vector generation controller (132), the mapping controller (134), or the training controller (136). An example of the computer processor (128) is described with respect to the computer processor(s) (502) of FIG. 5A.

The server (126) also includes a language model (130). The language model (130) is a natural language processing machine learning model. An example of the language model (130) may be a large language model, such as CHATGPT®. However, many different language models may be used. Use of the language model (130) is described with respect to FIG. 2.

The server (126) also includes a vector generation controller (132). The vector generation controller (132) may be an embedding machine learning model that is trained to convert natural language text into a vector data structure composed of features and values. An example of the vector generation controller (132) may be an ADA-002 machine learning model. However, many different embedding models may be used. Use of the vector generation controller (132) is described with respect to FIG. 2.

The server (126) also includes a mapping controller (134). The mapping controller (134) is software or application specific hardware which, when executed by the computer processor (128), essentially performs the method of FIG. 2. An example of a structure of the mapping controller (134) is shown in FIG. 3B. Thus, the mapping controller (134) may include both the language model (130) and the vector generation controller (132). However, the mapping controller (134) is shown separately from the language model (130) and the vector generation controller (132) in the example of FIG. 1A, because different architectural arrangements of the language model (130), vector generation controller (132), and mapping controller (134) are possible.

The server (126) also may include a training controller (136). The training controller (136) is software or application specific hardware which, when executed by the computer processor (128), trains one or more machine learning models (e.g., the language model (130) and the vector generation controller (132)). The training controller (136) is described in more detail with respect to FIG. 1B.

The system of FIG. 1A may include, or may interact with, one or more user devices (138). The user devices (138) are computing systems which may, or may not, be part of the system of FIG. 1A. The user devices (138) are used by one or more users. Users are humans using the user devices (138). An example of the user device (138) is shown in FIG. 4A.

Attention is turned to FIG. 1B, which shows the details of the training controller (136). The training controller (136) is a training algorithm, implemented as software or application specific hardware, which may be used to train one or more machine learning models (130) described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data in order to make predictions.

In one or more embodiments, some of the data in the data repository (100) of FIG. 1A may be stored in the form of one or more vectors. For example, the vectors (118), the prompt embedding vectors (120), the term embedding vectors (122), and the combined vectors (124) may be vectors.

Returning to the operation of the training controller (136), training starts with training data (176) which may be expressed as a training data vector. The training data (176) may be data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178) may be characterized as a program that has adjustable parameters. The program is capable of learning and recognizing patterns to make predictions. The output of the machine learning model may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model being used (supervised versus unsupervised machine learning), or may be pre-determined by a user (e.g., convergence occurs after a set number of training iterations, described below).

In the case of supervised machine learning, the convergence process (184) compares the output (182) to a known result (186). The known result (186) is stored in the form of labels for the training data. For example, the known result for a particular entry in an output vector of the machine learning model may be a known value, and that known value is a label that is associated with the training data.

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

In the case of unsupervised machine learning, the convergence process (184) may be compared to the output (182) or to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data (176) and then achieve convergence as described above for a supervised machine learning model (178). Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2 shows a flowchart of a method for mapping disparate language-based datasets using a language model, in accordance with one or more embodiments. The method of FIG. 2 may be implemented using the system of FIG. 1A.

Step 200 includes receiving a prompt for a language model trained to process natural language data. The prompt commands the language model.

The prompt may be received in a number of different manners. For example, the prompt may be generated by a computer technician in order to start the method of FIG. 2.

However, the prompt may be received automatically from some other computer process. For example, the prompt may be generated. Generating the prompt may include generating the prompt, prior to receiving the prompt, by retrieving a prompt template stored as natural language text. In this case, the prompt may be the prompt template.

The prompt template may be provided with an input encoding that permits injection of a feature into the prompt at runtime. In other words, the feature may be determined at runtime, and the feature then injected at step 204 into the prompt using the input encoding.

The prompt template may also be provided with one or more variable encodings that permit injection of variable prompt phrases into the prompt at runtime. Thus, as described further with respect to step 202, at runtime a variable might be specified that indicates which of multiple variable prompts may be injected into the prompt template at runtime.

Step 202 includes generating an updated prompt by at least injecting a feature into the prompt. The feature may be received from some other process (e.g., from a prediction model or explanation model (see FIG. 4A)). The feature also may be received by some other process or by user input. For example, the feature may be received as a string of natural language text from user input (as opposed to being received from a prediction model or explanation model). The feature may be received by a variety of different means. In addition, while the term “the feature” is used, one or more embodiments contemplate that “the feature” may be multiple features that may be injected to the prompt. Accordingly, the terms “the feature,” “the first feature,” or “the selected feature” should be read as contemplating reference to either a single feature or multiple features.

As an example, the feature may be generated by applying a prediction model to user data to generate a prediction regarding a user. The user data includes multiple features. Generating the feature then includes determining a first feature in the multiple features that contributed, during application of the prediction model to the user data, to the prediction of more than at least one other feature in the features. Determining the first feature may be performed by an explanation model that interacts with the prediction model to determine the top feature or features (used by the prediction model) that contributed to the prediction made by the prediction model. The feature output by the explanation model is the feature injected automatically into the prompt template using the input encoding.

In another example, the feature may be generated by applying a prediction model to user data to generate a prediction regarding a user. Again, the user data includes multiple features. Again, a first feature in the multiple features may be determined. The first feature contributed, during application of the prediction model to the user data, to the prediction of more than at least one other feature in the multiple features. The first feature is specified as the feature to be injected into the prompt by way of the input encoding. However, in addition in this example, a variable prompt is also injected into the prompt. A number of variables values are provided together with the feature. The variables values are compared to a file that contains multiple variable prompts, where each variable prompt is associated with a variable code stored in the file. When a variable value matches a variable code, then a prompt string stored in the file that is associated with the variable code is also injected into the prompt. An example of the variable values, variable codes, and prompt strings is shown in FIG. 4C.

In still another example, all features used by the prediction model to generate a prediction may be injected into the prompt and thus considered by the language model. For example, the contributions of some or all features used by the prediction model may be determined by an explanation model. The contributions and the features are then injected into the prompt, possibly together with one or more variable prompts. When the updated prompt is subsequently vectorized and executed (as explained below at steps 210), some or all of the features are mapped to one or terms. For example, multiple features may be mapped to multiple terms in the second dataset. In a more specific example, multiple features may be mapped to multiple adverse action notice codes (see the example of FIG. 4A). Thus, the contributions of multiple features to the prediction may be aggregated at the level of the adverse action notice codes (i.e., the second dataset), as described with respect to an example given with respect to step 210, below.

As indicated above, the feature or features may be injected to the prompt at runtime by way of an input encoding present in the prompt. The received feature or features may be injected into the prompt by, for example, inserting the received feature or features into the input encoding in the prompt. The received feature or features may be further modified prior to being injected into the prompt, such as by changing or summarizing the text of the received feature or features.

Step 204 includes applying a vector generation controller to the updated prompt to generate a set of prompt embedding vectors. The vector generation controller may include an encoding model. The encoding model takes, as input, the updated prompt. The output of the encoding model is the set of prompt embedding vectors. Thus, the vector generation controller transforms the prompt stored as a text data structure into one or more vector data structures.

For example, the vector generation controller may parse the prompt into one or more sets of words contained in the prompt in a process known as tokenization. Each of the one or more sets of words is a token. The encoding model may convert each token into a separate vector data structure. Thus, the prompt may be converted into multiple vector data structures, each representing one token.

However, the vector generation controller may also convert the entire updated prompt as a single token. In this case, the prompt may be converted into a single vector data structure.

Step 206 includes applying the vector generation controller to a language dataset to generate a set of term embedding vectors. The language dataset includes multiple terms disparate from the feature or features.

In order for the language model to be able to compare the feature(s) to the terms, both the terms and the feature(s) are converted into vector data structures in order that the language model may process and compare the two disparate datasets (i.e., to compare the feature(s) to the terms). Thus, the encoding model of the vector generation controller converts the language dataset into a set of term embedding vectors.

The set of term embedding vectors at least includes the list of terms. In other words, the list of terms is stored as vectorized tokens.

However, the set of embedding vectors may also include other information. For example, the language dataset also may include verbiage, which is encoded as one or more vectorized verbiage tokens. The language dataset also may include metadata, which is encoded as one or more vectorized metadata tokens. The association between each set of the verbiage and each of the terms is maintained so that the language model understands that a particular set of verbiage is associated with a particular term. The association between each set of the metadata and each of the terms is maintained so that the language model understands that a particular set of metadata is associated with a particular term.

As explained above, the verbiage may be words that describe the meaning of a corresponding term. Thus, the language model may use the verbiage associated with the list of terms to aid in comparing the feature(s) to the list of terms. Similarly, the metadata may include information that provides context so that the language model may use the metadata associated with the list of terms in comparing the feature(s) to the list of terms.

In any case, the vector generation controller is applied to the language dataset to generate a set of term embedding vectors. The term embedding vectors may be arranged in different manners. For example, each term embedding vector may be a tuple that describes a term, the corresponding verbiage for the term, and corresponding metadata for the term. However, each term embedding vector may represent a vectorized token of a single word in the language dataset, whether that word is from the list of terms, the verbiage, or the metadata. In this latter case, the relationships between the list of terms, the verbiage, and the metadata may also be encoded as vectors. In any case, the term information in the language dataset that is to be used by the language model is available in one or more term embedding vectors.

The term embedding vectors may be received by a variety of different means. In an example, the term embedding vectors are generated in advance of a runtime operation. Thus, the language model may simply call or receive the term embedding vectors at runtime when the feature(s) will be compared to the list of terms to generate the mapping between the feature(s) and the list of terms. However, in an embodiment, some or all of the term embedding vectors may be generated at runtime.

Step 208 includes combining the set of term embedding vectors with the set of prompt embedding vectors to generate a set of combined vectors. Combining the vectors may include adding, appending, mixing, or otherwise joining each of the term embedding vectors and the prompt embedding vectors into a group of vectors that may be referred to as the set of combined vectors.

Combining the vectors also may include providing each of the set of term embedding vectors and the set of prompt embedding vectors directly to the language model prior to execution of the language model. In other words, combining the vectors does not necessarily create a single combined vector or a group of vectors that is logically distinct from the set of term vectors and the set of prompt embedding vectors. However, it is also possible that the two sets of vectors are combined into a single vector known as a one hot vector. Other combinations of the sets of vectors are also possible.

Step 210 includes applying a language model to the set of combined vectors to generate a mapping between the feature(s) and a term in the set of terms. Applying the language model includes supplying the set of combined vectors as input to the language model. The output of the language model is controlled by the prompt (i.e., the set of prompt embedding vectors). The output of the language model is therefore in the form of a mapping between the feature(s) and one or more terms in the list of terms.

The mapping may be ranked in the case of the feature(s) being associated with multiple terms. For example, the language model may determine that the term that most likely matches the top feature (the top feature is the feature that most contributed to the decision of a prediction model) may be a first term. The term that matches a second feature (the second feature is the feature that next most contributed to the decision of the prediction model) may be a second term. The term that next most likely matches a third feature (the third feature is the feature that next most contributed to the decision of the prediction model, after the first feature and the second feature) may be a third term, and so on. The terms may then be ranked in a variety of orders, though one or more embodiments contemplate that the list of matching terms may be ranked in order of descending probability (i.e., the first term, the second term, and then the third term). The probability that a term matches the feature may also be displayed together with the list of terms predicted to match the feature.

In any case, in this example, the contributions of multiple features to the prediction are aggregated at the level of the terms in the second dataset. Specifically, the language model may consider some or all of the features used by the prediction model, together with the relative contributions of each of those features to the prediction output by the prediction model. Again, the contributions of the features were determined by an explanation model. Accordingly, because the language model considers some or all of the features and their corresponding contributions to the prediction, the output of the language model is a list of terms (in the second dataset) that map to the list of features. The list of terms is ranked in order of the corresponding features that most contributed to the prediction output by the prediction model.

When generating the mapping, it is possible that multiple features may map to one term. In other words, there may be a many-to-one mapping of one or more features in the first dataset to one or more terms in the second dataset. In this case, the relative contributions of the features that map to a single term may be combined prior to sorting the list of terms. Thus, if multiple features map to a single term, the relative importance of that single term may be elevated to a higher ranking in list.

For example, consider the case where an explanation model outputs a relative importance value for each of the features used by the prediction model. The relative importance value is a numerical assessment of how much a given feature contributed to the prediction output by the prediction model, relative to the other features used by the prediction model to generate the prediction. Assume feature 1 has a relative importance of 0.5, as determined by the explanation model, and no other feature has a higher relative importance value than 0.4. Feature 1 maps to term 1. Assume further that feature 2 has a relative importance value of 0.3 and that feature 3 has a relative importance value of 0.2. Both features 2 and feature 3 map to term 2. Thus, the relative importance of term 2 may be considered as having a combined relative importance of 0.3+0.2=0.5. Because a relative importance of 0.5 exceeds the relative importance of 0.4, term 2 is ranked ahead of term 1 in the list of mapped terms.

In view of the above examples, references to “injecting a feature into the prompt” contemplate injecting multiple features into the prompt. Accordingly, the term “a feature” should be read throughout this document as referring to “one or more features.”

In addition, generating the mapping may include an extended procedure where the language model may suggest one or more new terms for mapping to the feature, particularly in the case where the model fails to map any of the features in the first dataset to the terms in the second dataset. For example, consider a case in which no existing term in the second dataset is a good mapping fit for one or more features in the second dataset, or the case where one or more of the terms in the second data are deemed “unsuitable.” The term “unsuitable” is defined as the term having a semantic distance to the feature that fails to satisfy a predetermined threshold. The term “unsuitable” also contemplates that no suitable term is available.

In this case, the prompt (or a variable prompt) may be further adjusted to request that the language model propose a new term with new corresponding verbiage. For example, the prompt may be adjusted by adding an instruction to add a new adverse action notice (a new member of the second dataset) together with new verbiage for the new adverse action notice (new verbiage associated with the new member of the second dataset) if existing adverse actions notices in the second dataset are not a good fit. A “good fit” may be defined as semantic distance(s) between the feature and the existing term(s), as calculated by the language model, satisfying a pre-determined threshold semantic distance. If the language model generates a new adverse action notice (i.e., a new term in the second dataset) and new verbiage, then the new adverse action notice may be added to the second dataset for future executions of the method of FIG. 2.

Step 212 includes presenting the mapping. Presenting the mapping, generally, is a computer operation that uses the mapping to accomplish a result. For example, presenting the mapping may include generating a response text based on the term. The response text may be taken from the verbiage associated with the term. Then, presenting the mapping also includes generating an electronic message using the response text. In this case, presenting also includes transmitting the electronic message to a user device. The user of the user device may be a person who initiated determination of a prediction by a prediction model that used the feature, in which case the message may describe why the prediction applied to the user. An example of this procedure is provided in FIG. 4A.

In another example, presenting the mapping may involve the introduction of some other text. For example, like the above example, presenting may include generating an electronic message that includes the mapping, and then transmitting the mapping to a computing device. However, the computing device executes some other computer process for automatically determining a presentation message to be consumed by the user. In an embodiment, the presentation message may be generated by a human technician using the computing device. In either case, after generating the presentation electronic message, the presentation electronic message is transmitted to the user.

Presenting the mapping may also include storing the mapping in a non-transitory computer readable storage medium. Presenting the mapping may also include transmitting the mapping to some other computer process that performs functions unrelated to message generation. For example, the mapping may be used in scientific research such that scientific principles may be applied to the identified term or terms in order to infer a property that applies to the feature. In a specific example, the feature may be a star and the terms may represent frequencies of light. Once the terms (frequencies of light) are inferred, the temperature of the star (the feature) may be inferred automatically using a formula that relates frequencies of light to the temperature of an object.

Thus, presenting the mapping may include many different computing processes. Accordingly, presenting the mapping is not limited to message generation.

The method of FIG. 2 may be varied. For example, the method of FIG. 2 may include more or fewer steps, or the order of the steps of FIG. 2 may be varied. As an example, the method of FIG. 2 also may include generating the language dataset.

Generating the language dataset may include adding the list of terms to the language dataset. For example, the terms may be collected from one or more sources and stored as a list of terms of interest.

Generating the language dataset also may include adding verbiage related to the terms to the language dataset. The verbiage may be information describing each of the terms. Thus, the verbiage may be considered to be sets of verbiage, where each of the sets of verbiage corresponds to and describes one of the terms in the list of terms. The verbiage need not describe the terms. For example, the verbiage may be text to be transmitted to a user if the corresponding term is matched to the feature at the mapping of step 210. The verbiage may include combinations of a description for the corresponding term and a message to be sent if the corresponding term matches the feature. The verbiage also may include other information of interest that pertains to the corresponding term.

Generating the language dataset also may include adding metadata related to the terms to the language dataset. The metadata may include information such as the source where the corresponding term was found, the time the corresponding term was added to the list of terms, the entity type to which the corresponding term may apply or may not apply, and a variety of other information.

Generating the language dataset also may include both adding the verbiage and the metadata to the terms. Generating the language dataset may also include arranging the language dataset in files composed of duples, triplets, or n-tuples of information associated with each term. Thus, each file may be an n-tuple of one term and information associated with the one term. Generating the language dataset may also include using an embedding model to encode or embed the files into a vector space (i.e., to generate the term embedding vectors).

The method of FIG. 2 may be further extended by adding a testing step. For example, the method of FIG. 2 also may include testing the mapping against a list of allowed mappings. If the testing result is positive (i.e., the mapping of the feature to the term is an allowed mapping), then the result is returned and presented as in step 212. However, if the result of the testing is a negative result (i.e., the mapping of the feature to the term is not an allowed mapping), then the updated prompt is further adjusted to generate an adjusted prompt. Then, the vector generation controller is reapplied to the adjusted prompt to generate an adjusted set of prompt embedding vectors. Then, the set of term embedding vectors is combined with the adjusted set of prompt embedding vectors to generate an adjusted set of combined vectors. Then, the language model is reapplied to the adjusted set of combined vectors to generate a new mapping.

Testing may continue and the process repeated if a subsequent mapping is not on the list of allowed mappings. In an embodiment, once a threshold number of negative results of retesting have been exceeded, then the mapping may be returned as a failure result. In other words, presenting the mapping at step 212 may include a message that the mapping failed.

In still another embodiment, the method of FIG. 2 contemplates performing data structure transformations as part of the process described above. For example, the feature may be a first tab separated value data structure that further includes a variable prompt. The language dataset may be second tab separated value data structures. In this case, the method further includes converting, prior to applying the vector generation controller to the feature, the first tab separated value data structure into a first object notation data structure.

Similarly, generating the updated prompt may include injecting the first object notation data structure into the prompt. Then, the method may include converting, prior to applying the vector generation controller to the language dataset, the second tab separated value data structures into second object notation data structures. The vector generation controller then may be applied to the language dataset by applying the vector generation controller to the second object notation data structures.

In addition, one or more embodiments contemplate different methods from those shown in FIG. 2. For example, one or more embodiments contemplate a method of generating a database that stores the language dataset, the term embedding vectors, or other information.

The method may include receiving a list of terms. Receiving the list of terms may be performed as described above with respect to FIG. 2. The method then includes receiving verbiage corresponding to the list of terms. Each term in the list of terms corresponds to a set of verbiage in the verbiage. The verbiage may be received as described above with respect to FIG. 2.

The method then includes receiving metadata. Each term in the list of terms corresponds to a set of metadata in the metadata. The metadata may be received as described above with respect to FIG. 2. The method then includes transforming the list of terms, the verbiage, and the metadata into a language dataset including a set of data structure files. Each file in the set of data structure files may include a triplet of a term, the set of verbiage for the term, and the set of metadata for the term. The method then includes applying a vector generation controller to the language dataset to generate term embedding vectors. Each of the term embedding vectors includes one or more embedding vectors corresponding to a file in the set of data structure files. The method then includes storing the term embedding vectors in a non-transitory computer readable storage medium. The term embedding vectors may be stored in a database within the non-transitory computer readable storage medium. The method then includes storing prompt templates in the non-transitory computer readable storage medium. Each of the prompt templates includes a command to map a feature to one or more of the terms in the list of terms. The method then includes storing variable prompts in the non-transitory computer readable storage medium. The variable prompts are configured to modify the prompt templates.

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3A and FIG. 3B show a dataflow for mapping disparate language-based datasets using a language model, in accordance with one or more embodiments. The dataflow of FIG. 3A and FIG. 3B may be implemented using the system of FIG. 1A.

FIG. 3A shows a dataflow for generating a database prior to a use phase. A list of terms (300), a verbiage for terms (302), and a metadata (304) are retrieved or received. The list of terms (300), the verbiage for terms (302), and the metadata (304) may be retrieved or received as described with respect to FIG. 2.

The list of terms (300), the verbiage for terms (302), and the metadata (304) are combined into a language dataset (306). The language dataset (306) is arranged in a set of files (i.e., data structures). Each file in the set of files contains an n-tuple (e.g., a triplet) of a term, a corresponding set of verbiage, and a corresponding set of metadata.

Next, the language dataset (306) is provided as input to a vector generation controller (308). The vector generation controller (308) includes an embedding model. The embedding model transforms the language dataset (306) into a set of term embedding vectors (312). The term embedding vectors (312) may, or may not, be arranged in individual files that correspond to the sets of files in the language dataset (306). The term embedding vectors (312) are then stored in a database (310) which is stored in a non-transitory computer readable storage medium.

The database (310) may store other information as well. For example, the database (310) may include one or more prompt templates (314). The database (310) also may store one or more variable prompts (316).

The dataflow shown in FIG. 3A reflects a preparation phase of one or more embodiments. At the conclusion of the preparation phase, the term embedding vectors (312), the prompt templates (314), and the variable prompts (316) are available during a runtime phase. The runtime phase is shown in the dataflow of FIG. 3B.

FIG. 3B shows a dataflow for mapping disparate datasets using the database shown in FIG. 3A. The dataflow takes place between the database (310) (which may be the database (310) shown in FIG. 3A) and a mapping controller (318) (which may be the mapping controller (134) shown in FIG. 1A). The mapping controller (318) performs the actions described with respect to FIG. 3B, though the return mapping process (346) may be a process other than the mapping controller (318). The term “process,” as used herein, refers to software or application specific hardware which, when executed by a processor, performs the corresponding function.

A combination of information is combined into a feature input (326). The information includes one or more variables (320). The variables (320) will be used to determine which variable prompts will be added to the updated prompt. The information includes one or more features (322). The features (322) may be pre-determined, or may be output by a prediction model (as shown in FIG. 4A). The feature definitions (324) may define the features in natural language test. The feature definitions (324) may be the part of the verbiage (106), or the metadata (108) described with respect to FIG. 1A.

The variables (320), the features (322), and the feature definitions (324) are combined into the feature input (326). The feature input (326) is provided as input to a prompt generation process (328). The prompt generation process (328) receives or retrieves an appropriate prompt template from the prompt templates (314) in the database (310). The “appropriate” prompt template may be selected by identifying the type of feature and selecting a prompt template accordingly. A human technician may select the “appropriate” template. The “appropriate” template may be automatically determined based on some other information ascertainable at the time the prompt template is retrieved or received by the prompt generation process (328).

The prompt generation process (328) also may receive or retrieve one or more variable prompts from the variable prompts (316) in the database (310). Which of the variable prompts (316) are injected into the prompt template may be determined based on the variables (320).

The one or more variable prompts are combined with the prompt template during the prompt generation process (328). The prompt generation process (328) also may inject one or more of the features (322) into the prompt template. In an embodiment, the feature definitions (324) may be added by the prompt generation process (328) into the prompt template.

The output of the prompt generation process (328) is the updated prompt (330). The updated prompt (330) is then provided as input to a vector generation controller (332). The embedding model of the features (322) outputs one or more prompt embedding vectors (334).

The prompt embedding vectors (334) are then provided as input to a combining process (336). The combining process (336) also retrieves or receives one or more of the term embedding vectors (312) from the database (310). The combining process (336) combines the term embedding vectors (312) and the prompt embedding vectors (334) into one or more combined vectors (338).

The combined vectors (338) are provided as input to a language model (340). The language model (340) outputs the mapping (342). The mapping (342) maps the feature to at least one term in the set of terms. The mapping (342) may be immediately returned via the return mapping process (346), described below.

The mapping (342) may be provided to a testing process (344). If the testing process is a negative result (e.g., the mapping (342) is not on an allowed list of mappings), then the data flow returns to the prompt generation process (328). The updated prompt is adjusted and the process repeats. If the testing process is positive (e.g., the mapping (342) is on the allowed list of mappings), then the data flow proceeds to the return mapping process (346) and the mapping (342) is presented.

The testing process (344) may be repeated a threshold number of times. At each repeat of the testing process (344), assuming a positive result at each testing, the process is repeated, and a new mapping is provided to the return mapping process (346). If the testing is performed multiple times, and at least one positive testing is achieved, then the mapping for the positive testing is provided to the return mapping process (346). However, if the threshold number of times occurs and only negative results are returned, then the data flow may terminate.

FIG. 4A shows an example of using a mapping disparate language-based dataset using a language model in a particular application, in accordance with one or more embodiments. The example of FIG. 4A may be performed using one or more of the computing system of FIG. 1A, the method of FIG. 2, and the dataflows of FIG. 3A and FIG. 3B.

Benjamin (400) is a human user applying for a loan. Benjamin (400) uses a user device (402) to supply user data in a loan application (404). The loan application (404) (i.e., the user data for Benjamin (400)) is vectorized and converted into an application vector. The application vector is provided as input to a prediction model (406). A server (408) executes the prediction model (406). The prediction model (406) uses multiple features during execution to generate a prediction (410) whether Benjamin (400) is a credit worthy individual.

In the example of FIG. 4A, the prediction model (406) predicts that Benjamin (400) has insufficient creditworthiness to receive the loan for which Benjamin (400) applied. Thus, Benjamin (400) is automatically denied the loan.

At this point, a law or lender policy may require that Benjamin (400) receive a reason Benjamin (400) was denied the loan. However, the prediction model (406) is a “black box.” In other words, the prediction model (406) simply outputs the prediction (410) that Benjamin (400) has insufficient creditworthiness for the loan, without explaining why.

Nevertheless, another machine learning model, the explanation model (412), may determine which one or more of the features in the prediction model (406) most contributed to the prediction (410) that Benjamin (400) had insufficient creditworthiness. The prediction (410) may receive the prediction (410) as input and may interact with the prediction model (406) when executed by the server (408). The prediction model (406) generates, as output, the top feature (414) among all of the features of the prediction model (406) that most contributed to the prediction (410) during execution of the prediction model (406). The top feature (414) may include multiple features, if it desirable to determine the top set of features that most contributed to the prediction (410) during execution of the prediction model (406).

However, the features, even if expressed in natural language text, may not be appropriate for transmission to Benjamin (400). For example, the top feature (414) may be recorded as “net_lv” in the application vector that was input to the prediction model (406). However, the text string “net_lv” may be incomprehensible to Benjamin (400) as a reason for denial of the loan. Furthermore, the term “net_lv” may not satisfy a legal requirement that explains the denial of the loan using approved text.

In the example, such approved text exists in the form of adverse action text (424), described below. However, mapping the top feature (414) to a corresponding adverse action text (424) is non-trivial. For example, the text “net_lv” may have little or no correspondence to the corresponding adverse action text (424), which may read “your annual income is insufficient to support the loan requested.” While theoretically, the term “net_lv” may be directly mapped to the required text, such a mapping is impractical in this example because the feature may change, the adverse action text (424) may change, or the feature “net_lv” may also map to other message controllers (434) which do not relate to the income that Benjamin (400) reported on the loan application (404).

Thus, the top feature (414) is provided as input to a mapping controller (416), which is executable by the server (408). The mapping controller (416) also may take, as input, one or more adverse action vectors (428), including an adverse action vector 1 (420). The adverse action vector 1 (420) is shown in more detail for explanation purposes, but in this example the adverse action vectors (428) each include the details of the adverse action vector 1 (420).

The adverse action vector 1 (420) includes an adverse action code (422). The adverse action code (422) is a code which may be used to reference the adverse action text (424). The adverse action text (424) is the actual text to be returned to Benjamin (400). The adverse action vector 1 (420) also includes metadata (426) which described, among other information, the application that Benjamin (400) uses to submit the Loan Application (404). That metadata (426) may be used by the mapping controller (416) as part of the mapping process, or the metadata (426) may be used to determine a prompt variable. For example, had Benjamin (400) used another application to submit the loan application (404), then a different prompt variable may have been used during a prompt injection process.

The adverse action code (422), the corresponding adverse action text (424), and the corresponding metadata (426) were previously submitted to a vectorization or embedding process. Thus, the adverse action vector 1 (420) is stored in the database (418) and ready for retrieval or sending to the mapping controller (416) during the mapping process. The adverse action vector 1 (420), as indicated above, may be one of many similarly structured adverse action vectors (428).

The database (418) also may store one or more prompt templates (430) and one or more variable prompts (431). The mapping controller (416) may retrieve or be sent one of the prompt templates (430) as part of the prompt generation process described in FIG. 2 or FIG. 3A. The mapping controller (416) may retrieve or be sent one or more of the variable prompts (431) as part of the prompt generation process described in FIG. 2 or FIG. 3A. The mapping controller (416) may inject the top feature (414) into the prompt template and may further update the prompt template to include one or more of the variable prompts (431).

The updated prompt is provided to a language model, which is included in the mapping controller (416). The mapping controller (416) is executed by the server (408) on the updated prompt (which includes a vectorized form of the top feature (414)), together with the adverse action vectors (428). The output of the mapping controller (416) is a mapping (432).

The mapping (432) maps the top feature (414) to one of the adverse action vectors (428). In this example, the mapping (432) maps the top feature (414) to the adverse action code (422) in the adverse action vector 1 (420).

The adverse action code (422) is provided to a message controller (434), which may access the adverse action text (424) associated with the adverse action vector 1 (420). The message controller (434) generates an electronic message (436) which contains the adverse action text. The adverse action text is a human-readable message which explains why Benjamin (400) was denied the loan. The electronic message (436) is returned to the user device (402) for display or other presentation to Benjamin (400).

FIG. 4B and FIG. 4C show examples of prompts and prompt variables, in accordance with one or more embodiments. FIG. 4B shows a prompt template (450). The prompt template (450) relates to a prompt commanding a language model to map a feature (i.e., the feature (112) in FIG. 1A) to one or more adverse action notices (AANs, as shown in the prompt below) (i.e., the terms (104) FIG. 1A). In FIG. 4B and FIG. 4C, the word “you” refers to a command that is addressed to the language model (i.e., the language model will interpret the word “you” as being a command to the language model to behave according to the subsequent text).

The prompt template (450) is an example of a prompt that may be provided as input to a language model, such as the language model (130) of FIG. 1A or the language model (340) of FIG. 3B. The prompt template (450) includes encoding which permits the embedding of the feature to which adverse action note (AAN) codes (i.e., a second, disparate dataset) are to be compared. For example, the feature encoding (452) includes an instruction to the language model that “the feature name is” followed by brackets into which the top feature will be inserted in place of the term “feature name” inside the brackets. Thus, once the actual feature name (e.g., “net_lv”) of the top feature is known, that actual feature name is injected between the brackets in the 452.

The prompt template (450) also includes multiple sentences that instruct the language model on how the language model is to compare the feature to the AAN codes. The prompt template (450) also includes sentences that instruct the language model on how to return the mapping. Use of the prompt template (450) is described with respect to FIG. 2 and FIG. 3B.

FIG. 4C shows an example of a variable prompt file (480). The variable prompt file (480) includes two variable prompts, variable prompt 1 (482) and variable prompt 2 (484). However, the variable prompt file (480) may include more or fewer variable prompts.

In most cases, not all variable prompts will be injected into the updated prompt during the prompt generation process described in FIG. 2 and FIG. 3B. Instead, a variable encoding provided to the mapping controller (e.g., the mapping controller (134) of FIG. 1A) may be used to identify which of the variable prompt file (480) will be injected into the prompt template (450).

In the variable prompt file (480), two variable encodings are present: PG (486) and SBCS (488). The presence or absence of the variable encoding in the language dataset may influence which, if any, of the variable prompts in the variable prompt file (480) are injected into the prompt template (450).

For example, if the prompt controller receives metadata in the language dataset that “PG” is present, then the mapping controller will inject the variable prompt (490) into the prompt template (450). However, if the metadata in the language dataset does not include the encoding variable “PG,” then the mapping controller will instead inject the variable prompt (490) into the prompt template (450). A similar prompt injection procedure is followed with respect to the SBCS (488) variable encoding.

Once the feature is injected into the prompt template (450) and any variable prompts are injected into the prompt template (450), the prompt template (450) is treated as an updated prompt. The updated prompt is then encoded and provided to the language model in the form of one or more prompt embedding vectors (e.g., the prompt embedding vectors (120) of FIG. 1A).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a prompt for a language model trained to process natural language data, wherein the prompt commands the language model;
generating an updated prompt by at least injecting a feature into the prompt;
applying a vector generation controller to the updated prompt to generate a set of prompt embedding vectors;
applying the vector generation controller to a language dataset to generate a set of term embedding vectors, wherein the language dataset comprises a plurality of terms disparate from the feature;
combining the set of term embedding vectors with the set of prompt embedding vectors to generate a set of combined vectors;
applying the language model to the set of combined vectors to generate a mapping between the feature and a term in the plurality of terms; and
presenting the mapping.

2. The method of claim 1, further comprising:
generating the language dataset by:
adding the plurality of terms to the language dataset, and
adding metadata related to the plurality of terms to the language dataset.

3. The method of claim 1, further comprising:
generating the feature by:
applying a prediction model to user data to generate a prediction regarding a user, wherein the user data comprises a plurality of features,
determining a first feature in the plurality of features that contributed, during application of the prediction model to the user data, to the prediction more than at least one other feature in the plurality of features, and
specifying the first feature as the feature.

4. The method of claim 1, further comprising:
generating the feature by:
applying a prediction model to user data to generate a prediction regarding a user, wherein the user data comprises a plurality of features,
determining a first feature in the plurality of features that contributed, during application of the prediction model to the user data, to the prediction more than at least one other feature in the plurality of features, and
specifying the first feature as the feature,
wherein generating the updated prompt further comprises adding a variable prompt to the prompt.

5. The method of claim 1, further comprising:
generating, prior to receiving, the prompt by retrieving a prompt template stored as natural language text, wherein the prompt comprises the prompt template.

6. The method of claim 1, further comprising:
testing the mapping against a list of allowed mappings, wherein returning the mapping is performed responsive to a positive result of the testing;
adjusting, responsive to a negative result of the testing, the updated prompt to generate an adjusted prompt;
reapplying the vector generation controller to the adjusted prompt to generate an adjusted set of prompt embedding vectors;
combining the set of term embedding vectors with the adjusted set of prompt embedding vectors to generate an adjusted set of combined vectors; and
reapplying the language model to the adjusted set of combined vectors to generate a new mapping.

7. The method of claim 1, further comprising:
testing the mapping against a list of allowed mappings, wherein returning the mapping is performed responsive to a positive result of the testing;
adjusting, responsive to a negative result of the testing, the updated prompt to generate an adjusted prompt;
reapplying the vector generation controller to the adjusted prompt to generate an adjusted set of prompt embedding vectors;
combining the set of term embedding vectors with the adjusted set of prompt embedding vectors to generate an adjusted set of combined vectors;
reapplying the language model to the adjusted set of combined vectors to generate a new mapping;
retesting the new mapping against the list of allowed mappings, wherein returning the mapping is performed using the new mapping responsive to a second positive result of retesting; and
returning, responsive to the retesting exceeding a threshold number of negative results, the mapping as a failure result.

8. The method of claim 1, wherein the mapping comprises an object notation language data structure specifying the feature and the term.

9. The method of claim 1, wherein presenting the mapping comprises:
generating a response text based on the term,
generating an electronic message using the response text, and
transmitting the electronic message to a user.

10. The method of claim 1, wherein presenting the mapping comprises:
generating an electronic message comprising the mapping;
transmitting the mapping to a computing device;
receiving, from the computing device, a presentation electronic message; and
transmitting the presentation electronic message to a user.

11. The method of claim 1, wherein the feature comprises a first tab separated value data structure that further includes a variable prompt, wherein the language dataset comprises a plurality of second tab separated value data structures, and wherein the method further comprises:
converting, prior to applying the vector generation controller to the feature, the first tab separated value data structure into a first object notation data structure,
wherein generating the updated prompt comprises injecting the first object notation data structure into the prompt, and
converting, prior to applying the vector generation controller to the language dataset, the plurality of second tab separated value data structures into a plurality of second object notation data structures,
wherein applying the vector generation controller to the language dataset comprises applying the vector generation controller to the plurality of second object notation data structures.

12. The method of claim 1, wherein the prompt includes a second command to suggest a new term if the term is unsuitable, wherein unsuitable is defined as the term having a semantic distance to the feature that fails to satisfy a predetermined threshold, and wherein applying the language model to the set of combined vectors further comprises:
determining the semantic distance between the feature and the term;
determining that the new term is unsuitable because the semantic distance fails to satisfy the predetermined threshold;
generating, by the language model, the new term; and
replacing, by the language model, the term with the new term such that the mapping that is generated is from the feature to the new term.

13. The method of claim 12, further comprising:
updating, after applying the language model to the set of combined vectors, the language dataset to include the new term.

14. The method of claim 12, wherein applying the language model to the set of combined vectors further comprises:
adding a third command to the prompt, wherein the third prompt commands the language model to generate verbiage for the new term.

15. A system comprising:
a processor;
a data repository in communication with the processor, the data repository storing:
a prompt and an updated prompt,
a language dataset comprising a plurality of terms, which includes a term,
a set of prompt embedding vectors, a set of term embedding vectors, and a set of combined vectors, and
a feature and a mapping between the feature and the term, wherein the feature is disparate from the plurality of terms;
a language model executable by the processor and trained to process natural language data, wherein the prompt commands the language model;
a vector generation controller executable by the processor; and
a mapping controller programmed, when executed by the processor, to perform a computer-implemented method comprising:
receiving the prompt,
generating the updated prompt by injecting the feature into the prompt,
applying the vector generation controller to the updated prompt to generate a set of prompt embedding vectors,
applying the vector generation controller to the language dataset to generate the set of term embedding vectors,
combining the set of term embedding vectors with the set of prompt embedding vectors to generate the set of combined vectors,
applying the language model to the set of combined vectors to generate the mapping, and
returning the mapping.

16. The system of claim 15, wherein the mapping controller is further programmed to perform the computer-implemented method by:
generating the language dataset by:
adding the plurality of terms to the language dataset, and
adding metadata related to the plurality of terms to the language dataset.

17. The system of claim 15, wherein the mapping controller is further programmed to perform the computer-implemented method by:
generating the feature by:
applying a prediction model to user data to generate a prediction regarding a user, wherein the user data comprises a plurality of features,
determining a first feature in the plurality of features that contributed, during application of the prediction model to the user data, to the prediction more than at least one other feature in the plurality of features, and
specifying the first feature as the feature.

18. The system of claim 15, wherein the mapping controller is further programmed to perform the computer-implemented method by:
generating the feature by:
applying a prediction model to user data to generate a prediction regarding a user, wherein the user data comprises a plurality of features,
determining a first feature in the plurality of features that contributed, during application of the prediction model to the user data, to the prediction more than at least one other feature in the plurality of features, and
specifying the first feature as the feature,
wherein generating the updated prompt further comprises adding a variable prompt to the prompt.

19. The system of claim 15 wherein, in the computer-implemented method, presenting the mapping comprises:
generating an electronic message comprising the mapping;
transmitting the mapping to a computing device;
receiving, from the computing device, a presentation electronic message; and
transmitting the presentation electronic message to a user.

20. A method comprising:
receiving a list of terms;
receiving verbiage corresponding to the list of terms, wherein each term in the list of terms corresponds to a set of verbiage in the verbiage;
receiving metadata, wherein each term in the list of terms corresponds to a set of metadata in the metadata;
transforming the list of terms, the verbiage, and the metadata into a language dataset comprising a set of data structure files, wherein each file in the set of data structure files comprises a triplet of a term, the set of verbiage for the term, and the set of metadata for the term;
applying a vector generation controller to the language dataset to generate a plurality of term embedding vectors, wherein each of the plurality of term embedding vectors comprises one or more embedding vectors corresponding to a file in the set of data structure files;
storing the plurality of term embedding vectors in a non-transitory computer readable storage medium;
storing a plurality of prompt templates in the non-transitory computer readable storage medium, wherein each of the plurality of prompt templates includes a command to map a feature to one or more terms in the list of terms; and
storing a plurality of variable prompts in the non-transitory computer readable storage medium, the plurality of variable prompts configured to modify the plurality of prompt templates.
